(19) United States
(12) Patent Application Publication
(10) Pub. No.: US 2023/0398617 A1
(43) Pub. Date: Dec. 14, 2023

(54) Sawblade and Hole Saw

(71) Applicant: Robert Bosch GmbH, Stuttgart (DE)

(72) Inventors: Donghui Ding, Hangzhou (CN); Daniel Grolimund, Zuchwil (CH)

(21) Appl. No.: 18/044,812

(22) PCT Filed: Sep. 6, 2021
(86) PCT No.: PCT/EP2021/074472

§ 371 Date: Mar. 10, 2023

(30) Foreign Application Priority Data
Sep. 22, 2020 (DE) 10 2020 211 809.4

(51) Int. Cl. B23D 61/14; B23D 61/04; B23D 61/12

(52) U.S. Cl. CPC B23D 61/14; B23D 61/04; B23D 61/127

(57) ABSTRACT

A sawblade includes a plurality of wave-shaped teeth formed on a continuous base section of the sawblade. Each of the teeth has a paired tooth base with a tooth base upper face and a hard metal blade arranged thereon. Each tooth base adjoins the hard metal blade arranged thereon in a flush manner on both sides along a longitudinal axis of the base section, and each hard metal blade and each tooth base upper face has two bevels and/or convexly rounded areas extending substantially along the longitudinal axis of the base section, wherein the teeth are designed to be set and/or unset.

### PRIOR ART

The present invention relates to a sawblade having a plurality of wave-shaped teeth which are formed on a continuous base section of the sawblade, the teeth each having an associated tooth base with a tooth base upper face and having a hard metal blade arranged thereon. The invention also relates to a hole saw.

A sawblade having a plurality of wave-shaped teeth which are formed on a continuous base section of the sawblade, the teeth each having a hard metal blade, is known from the prior art. For example, EP 0 054 885 A2 describes a sawblade in the form of a band sawblade which is equipped with hard metal plates. This band sawblade is supposed to have a long service life and a high permissible step speed and be suitable for cutting very hard materials, such as metals or stones. For this purpose, the band sawblade is unset, and the hard metal plates are fastened to seat surfaces which are perpendicular or inclined only slightly forward relative to the sawblade longitudinal extension. The hard metal plates have a height between ⅓ to ⅘ of a relevant tooth height and protrude on both sides beyond the sawblade thickness with undercut clearance widened portions.

### DISCLOSURE OF THE INVENTION

The invention relates to a sawblade having a plurality of wave-shaped teeth which are formed on a continuous base section of the sawblade, the teeth each having an associated tooth base with a tooth base upper face and having a hard metal blade arranged thereon. Each tooth base adjoins the hard metal blade arranged thereon in a flush manner on both sides along a longitudinal axis of the base section, and each hard metal blade and each tooth base upper face has two bevels and/or convexly rounded areas extending substantially along the longitudinal axis of the base section, the teeth being unset and/or set.

This results in comparatively smooth saw cuts combined with an increased cutting efficiency. In addition, a higher sawing speed is possible with improved service life of the sawblade. The hard metal blades end flush with the relevant tooth base of the tooth on both sides and are thus supported in a stable and particularly robust manner. Due to the complete support of the hard metal blades, a particularly long service life of the hard metal blades fastened to the teeth is obtained. The tooth base in turn preferably adjoins the base section of the sawblade in a flush manner. A tooth base upper face, formed by the relevant tooth base and the hard metal blade embedded in a flush manner in the upper side thereof, is planar and descends in a straight line from a tooth tip to the tooth back. In the context of the present description, the term “set” defines the bending, preferably in opposite directions, of directly successive teeth out of a central plane defined by the rectangular base section of the sawblade. All teeth of the sawblade preferably have the same height regardless of the presence of a set. The geometry of the teeth of the sawblade according to the invention preferably approximates the so-called K-shape in side view (cf., inter alia, Brockhaus, “Naturwissenschaften und Technik”; volume 4; page 224; 1989).

Preferably, the bevels of each hard metal blade have substantially the same width.

This results, inter alia, in reduced cutting forces and self-centering of the sawblade in the kerf in the material to be cut. The bevels increase the crack resistance and the impact resistance. In the context of the present description, the term “bevel” is understood to mean a planar or prismatic slant of a workpiece edge.

In one embodiment, the bevels of each tooth have a different width.

As a result, even more effective self-centering within the kerf is ensured.

Preferably, the convex rounded areas have substantially the same radius.

As a result, mechanical stresses in the region of the cut faces can be further reduced.

According to a technically favorable development, two directly successive teeth along the longitudinal axis are in each case set in opposite directions to one another.

Due to the clearance of the sawblade realized thereby, the cutting forces occurring in the sawing process can be reduced further.

Preferably, at least one tooth is unset, and the two teeth which directly follow said tooth along the longitudinal axis are set in opposite directions to one another, and this set sequence is repeated along the longitudinal axis over all the teeth of the sawblade.

This periodic set sequence results in a wider kerf.

In one development, it is provided that at least one tooth is unset, and two further teeth which directly follow said tooth along the longitudinal axis are set in opposite directions to one another at a first set angle, and two further teeth which directly follow the teeth set in opposite directions at the first set angle along the longitudinal axis are set in opposite directions to one another at a second set angle, and this set sequence is repeated along the longitudinal axis over all the teeth of the sawblade.

As a result, any tendency of the sawblade to jam in the workpiece can be reduced further. The width of the bevels, their bevel angle and/or the radii of the convex rounded areas can vary individually depending on the set angles.

The first set angle is preferably smaller than the second set angle.

As a result, the angles of the sets increase in the cutting direction.

The hard metal blades preferably form a tooth tip above a concave chip space, pointing in the cutting direction, of each tooth.

As a result, a high cutting or sawing performance is provided. A tooth back is substantially rectilinear.

Preferably, the hard metal blades are fixedly connected to the tooth base of the teeth, in particular joined thermally thereto.

This results in a particularly robust, easy to manufacture connection between the hard metal blades and the tooth base of the teeth bearing said blades.

Preferably, the base section of the sawblade is formed with a tempered steel, and the hard metal blades are preferably formed with a tungsten carbide-cobalt hard metal.

This ensures sufficient flexibility of the sawblade. Furthermore, an excellent cutting performance combined with a long service life of the sawblade is realizable.

The invention also relates to a hole saw. This hole saw is formed with a sawblade which is bent substantially into a ring and is preferably designed as described above.

As a result, a hole saw or a drill bit with a considerably improved cutting performance in relation to previously known solutions can be realized.

### BRIEF DESCRIPTION OF THE DRAWINGS

The invention is explained in more detail in the following description with reference to exemplary embodiments shown in the drawings, in which:

FIG. 1 shows a schematic partial side view of a first embodiment of a sawblade according to the invention,

FIG. 2 shows a schematic partial plan view of the sawblade of FIG. 1,

FIG. 3 shows a schematic front view of two teeth of the sawblade of FIG. 2,

FIG. 4 shows a schematic partial plan view of a second embodiment of a sawblade which is unset, with an otherwise identical design to the first embodiment,

FIG. 5 shows a schematic front view of two teeth of a third embodiment of a sawblade,

FIG. 6 shows a schematic front view of two teeth of a fourth embodiment of a sawblade,

FIG. 7 shows a schematic partial plan view of a fifth embodiment of a sawblade,

FIG. 8 shows a schematic front view of three teeth of the sawblade of FIG. 7,

FIG. 9 shows a schematic partial plan view of a sixth embodiment of a sawblade,

FIG. 10 shows a schematic front view of the five teeth of the sawblade of FIG. 9,

FIG. 11 shows a detailed partial front view of a tooth of the first embodiment of the sawblade,

FIG. 12 shows a detailed partial front view of a tooth of the third embodiment of the sawblade, and

FIG. 13 shows a detailed partial front view of a tooth of the fourth embodiment of the sawblade.

### DESCRIPTION OF THE EXEMPLARY EMBODIMENTS

For the sake of simplicity, structurally substantially identical elements having the same or comparable function are provided with the same reference signs throughout the drawings and are only described in detail once.

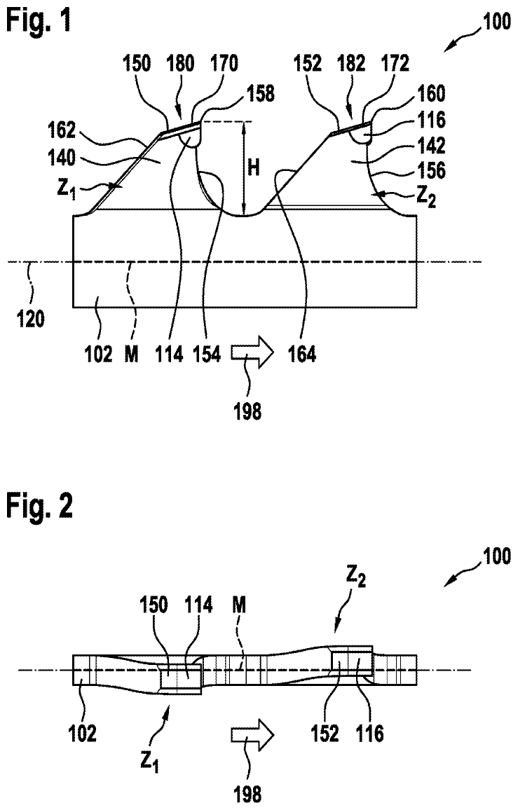

FIG. 1 shows a first embodiment of a sawblade 100, which preferably has a plurality of similar, wave-shaped teeth, of which only two teeth Z_{1,2}, representing all the other teeth of the sawblade 100, are indicated here. The teeth Z_{1,2} are preferably formed integrally on a continuous band-shaped or rectangular profile-like base section 102 of the sawblade 100.

The sawblade 100 having the base section 102 illustratively has a central plane M in which a longitudinal axis 120 runs. A preferred cutting direction 198 of the sawblade 100 is indicated by an arrow 198.

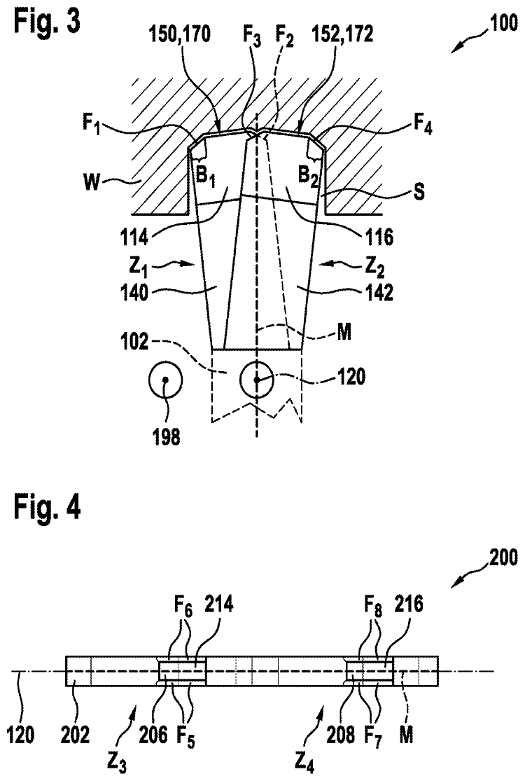

Each of the teeth Z_{1,2} preferably has an assigned, solid tooth base 140, 142 or a tooth shaft having a tooth base upper face 150, 152 and a hard metal blade 114, 116 arranged thereon. Illustratively, the hard metal blades 114, 116 each form a tooth tip 158, 160 above a chip space 154, 156, pointing in the cutting direction 198, of each tooth Z_{1,2}. The tooth base upper faces 150, 152 and upper faces 170, 172 of the hard metal blades 114, 116 embedded in the relevant tooth base 140, 142 adjoin one another in a flush manner and in each case form a tooth upper face 180, 182 which is substantially flat except for the continuous bevels (cf. in particular FIG. 3) and which descends from the elevated tooth tips 158, 160 to a relevant tooth back 162, 164 of the teeth Z_{1,2} preferably slightly linearly, i.e. does not run parallel to the longitudinal axis 120. For example, the tooth backs 162, 164 of the teeth Z_{1,2} are only approximately rectilinear here. The teeth Z_{1,2} and the not shown teeth of the sawblade 100 also preferably each have the same height H.

The hard metal blades 114, 116 are preferably fixedly connected to the relevant tooth base 140, 142 of the respectively assigned tooth Z_{1,2}, in particular thermally fixedly joined thereto. The thermal joining between the tooth bases 140, 142 of the teeth Z_{1,2} and the hard metal blades 114, 116 can be made, for example, by brazing or welding. The base section 102 of the sawblade 100 is preferably formed with a (highly) tempered steel, and the hard metal blades 114, 116 can be realized, for example, with a tungsten carbide-cobalt hard metal.

FIG. 2 shows the base section 102 of the sawblade 100 of FIG. 1, on which the teeth Z_{1,2} are formed, the hard metal blade 114 being fastened in the region of the tooth base upper face 150 of the tooth Z₁ and the hard metal blade 116 being fastened in the region of the tooth base upper face 152 of the tooth Z₂. In this case, the teeth Z_{1,2}, only by way of example, are set, i.e. in each case bent in opposite directions to one another out of the central plane M of the base section 102 of the sawblade 100. Alternatively, the teeth Z_{1,2} of the sawblade 100 can also be unset (cf. in particular FIG. 4). The sawblade 100 is guided in the cutting direction 198 through the workpiece to be cut, not shown here.

FIG. 3 shows the base section 102 of the sawblade 100 of FIG. 2, on which the set teeth Z_{1,2} are formed. The teeth Z_{1,2} of the sawblade 100 are illustratively located in a sawing channel S or a kerf of a workpiece W to be cut. The longitudinal axis 120 of the base section 102 runs within the central plane M of the base section 102, and the cutting direction 198 of the sawblade 100 through the workpiece W leads out of the drawing plane in the illustration of FIG. 3.

Preferably, each tooth base 140, 142 of each tooth Z_{1,2} in each case adjoins the hard metal blade 114, 116 arranged thereon in a flush manner on both sides along the longitudinal axis 120 of the base section 102. Furthermore, each hard metal blade 114, 116 and each tooth base upper face 150, 152 of the teeth Z_{1,2} preferably have in each case two continuous planar bevels F_{1, . . . , 4} or so-called slants extending substantially along the longitudinal axis 120 of the base section 102, i.e. in this case extending approximately perpendicular to the drawing plane. The tooth upper faces 150, 152 of the teeth Z_{1,2} lie behind the hard metal blades 114, 116 or the upper faces 170, 172 thereof in relation to the drawing plane.

The teeth Z_{1,2} can either be set or unset, as shown in the drawings here. In the first embodiment of the sawblade 100 shown here, the bevels F_{1, . . . , 4} preferably each have approximately the same width, wherein, for the sake of better clarity, only the widths B_{1,2} of the bevels F_{1, 4} on the outside relative to the central plane M are indicated.

FIG. 4 shows a second embodiment of a sawblade 200 having a base section 202 extending along the central plane M of FIG. 1 with the longitudinal axis 120. A plurality of teeth are preferably formed on the base section 202, of which only two teeth Z_{3,4} are shown and designated to represent all the others. A hard metal blade 214 is preferably again embedded flush with a tooth base upper face 206 of the tooth Z₃. Accordingly, the tooth base upper face 208 of the tooth Z₄ likewise has a hard metal blade 216. The tooth base upper face 206 and the hard metal blade 214 of the tooth Z₃ preferably each have a continuous bevel F_{5,6} on both sides, the bevels F_{5,6} being oriented approximately along the longitudinal axis 120. Accordingly, the tooth upper face 208 and the hard metal blade 216 of the tooth Z₄ are provided with the bevels F_{7,8} oriented in the direction of the longitudinal axis 120. Analogously to the first embodiment, the bevels F_{5, . . . , 8} each have approximately the same width.

In contrast to the first embodiment of the sawblade 100 according to FIG. 1 to FIG. 3, the teeth Z_{3,4} are unset, i.e. the teeth Z_{3,4} are each oriented parallel to the central plane M. This results in a design of the sawblade 200 that is completely mirror-symmetrical with respect to the central plane M.

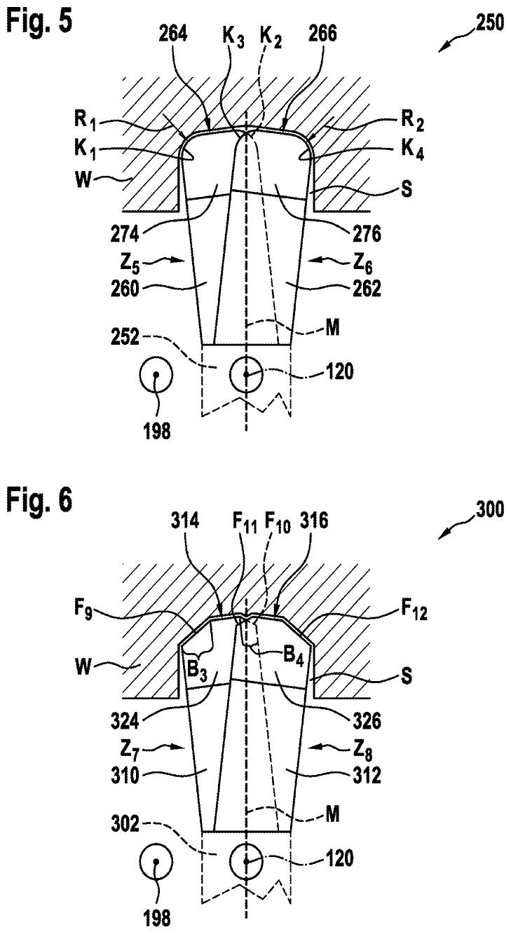

FIG. 5 shows a third embodiment of a sawblade 250, which preferably again comprises a band-shaped or rectangular profile-like base section 252. The sawblade 250 having the base section 252 preferably has the central plane M of FIG. 1 with the longitudinal axis 120 lying therein. On the base section 252 of the sawblade 250, a plurality of teeth alternately set in opposite directions to one another are preferably formed, of which only two teeth Z_{5,6} with their respective tooth bases 260, 262 or tooth shafts can be seen here. In the region of respective tooth base upper faces 264, 266 of the teeth Z_{5,6}, a hard metal blade 274, 276 is preferably again arranged in each case or is embedded in a flush manner in said upper face and fastened. The sawblade 250 guided in the sawing channel S moves in the cutting direction 198 of FIG. 1 through the workpiece W.

In contrast to the first two embodiments of the sawblades 100, 200 of FIG. 1 to FIG. 4, the hard metal blades 274, 276 and the tooth base upper faces 264, 266 of the teeth Z_{5,6} preferably do not have continuous, flat or planar bevels, but continuous convexly rounded areas K_{1, . . . , 4}. Preferably, the continuous convexly rounded areas K_{1,2} are formed on both sides on the tooth Z₅, and the convexly rounded areas K_{3,4} are formed on both sides on the tooth Z₆.

The convexly rounded areas K_{1, . . . 4} formed on both sides on the hard metal blades 274, 276 and on the tooth bases 260, 262 or the tooth base upper faces 264, 266 of the teeth Z_{5,6} preferably run at least approximately parallel to the longitudinal axis 120. The hard metal blades 274, 276 preferably in turn each adjoin the respective tooth bases 260, 262 of the teeth Z_{5,6} in a flush manner on both sides.

The convexly rounded areas K₁,K₄ on the outside relative to the central plane M preferably have the same radii R_{1,2}. The same applies to the radii of the inside convexly rounded areas K_{2,3} of the teeth Z_{5,6}, which radii are not indicated for the sake of better clarity. Deviating from this, the radii R_{1, . . . , 4} of the convexly rounded areas K_{1, . . . , 4} can all be the same size or can optionally differ by tooth or individually by tooth.

FIG. 6 shows a fourth embodiment of a sawblade 300 having a base section 302. Two teeth Z_{7,8} with their respective tooth bases 310, 312 are illustratively arranged on the base section 302 of the sawblade 300. In the region of tooth base upper faces 314, 316 of the teeth Z_{7,8}, which faces are assigned in each case to the tooth bases 310, 312, hard metal blades 324, 326 are preferably arranged or are embedded in said upper face in a flush manner and fastened. The teeth Z_{7,8}, as well as all the further, similar teeth of the fourth embodiment of the sawblade 300 shown here, preferably again have a set. The structural design of the other, not shown teeth of the sawblade 300 preferably corresponds to the teeth Z_{7,8} with respect to the structural design. The sawblade 250 guided in the sawing channel S preferably moves in the cutting direction 198 through the workpiece W.

In contrast to the embodiments of the sawblades described in FIG. 1 to FIG. 5, the hard metal blades 324, 326 as well as the tooth base upper faces 314, 316, adjoining thereto in a flush manner, of the teeth Z_{7,8} of the sawblade 300 preferably have continuous, flat or planar bevels F_{9, . . . , 12}, the widths of which are, however, preferably different. The bevels F_{9,12} on the outside relative to the central plane M preferably each have the same width; for the sake of better clarity, only the width B₃ of the bevel F₉ is indicated. The same applies to the widths of the two inside bevels F_{10,11}, of which only a width B₄ of the bevel F₁₀ of the tooth Z₈ is indicated. Preferably, the widths of the inside bevels F_{10,11} of the teeth Z_{7,8} are in each case smaller than the widths of the outside bevels F_{9,12}, so that the width B₃ of the outside bevel F₉ illustratively has a significantly larger width than the width B₄ of the inside bevel F₁₀.

The bevels F_{9, . . . , 12} provided on both sides on the hard metal blades 324, 326 and on the tooth bases 310, 312 or the tooth base upper faces 314, 316 of the teeth Z_{7,8} preferably run approximately parallel to the longitudinal axis 120. The hard metal blades 324, 326 preferably in each case terminate flush with the respective tooth bases 310, 312 of the teeth Z_{7,8} on both sides, resulting in, among other things, their high mechanical robustness and durability.

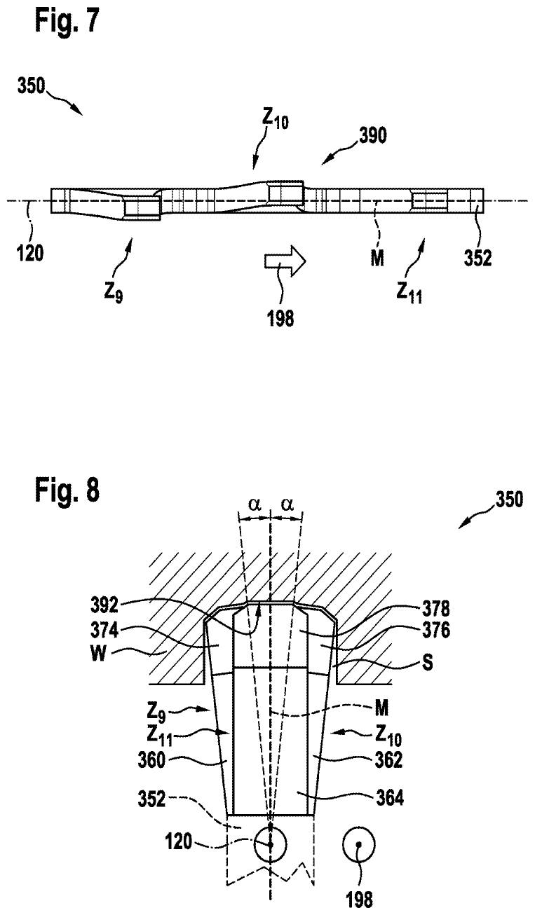

FIG. 7 shows a fifth embodiment of a sawblade 350, which preferably has a base section 352 on which illustratively three teeth Z_{9, . . . , 11} are formed, the constructive design of which, in particular the tooth geometry of which, corresponds merely by way of example with the shape of the teeth of the first embodiment of the sawblade in FIG. 1 to FIG. 3. The teeth Z_{9, . . . , 11} may also have convexly rounded areas and/or bevels with different widths analogous to the teeth of the first four embodiments described above. The sawblade 350 is guided in the cutting direction 198 through the workpiece to be cut, which is not shown here.

In contrast to the embodiments described in FIG. 1 to FIG. 6, the tooth Z₁₁ is here preferably unset or oriented parallel to the central plane M, while the teeth Z_{9,10} following this tooth counter to the cutting direction 198 are set in opposite directions to one another and thus realize a first set sequence 390. As a result of the setting, the teeth Z_{9,10} are bent in opposite directions out of the central plane M of the base section 352 of the sawblade 350. The set sequence 390 is preferably repeated over an entire longitudinal extension of the sawblade 350.

FIG. 8 shows the three teeth Z_{9, . . . , 11} of the sawblade 350 of FIG. 7. The sawblade 350 is located in the sawing channel S of the workpiece W. The sawblade 350 having the base section 352 is symmetrical with respect to the central plane M with the longitudinal axis 120 extending therein. The tooth Z₁₁ of the sawblade 350 is unset, whereas the teeth Z_{9,10} directly following this tooth counter to the cutting direction 198 are set in opposite directions to one another in each case at a first set angle α. The shape of the teeth Z_{9, . . . , 11} and their relevant structural design with three tooth bases 360, 362, 364 as well as the hard metal blades 374, 376, 178 preferably again corresponds to the structural design of the teeth of the first embodiment of the sawblade 100 according to FIG. 1 to FIG. 3.

Owing to the design of the teeth Z_{9, . . . , 11} according to the invention, a sawing channel bottom 392 is preferably largely smooth and burr-free and thereby stress-free. As a result, inter alia, the crack formation tendency in the sawing channel S and thus within the workpiece W can be significantly reduced.

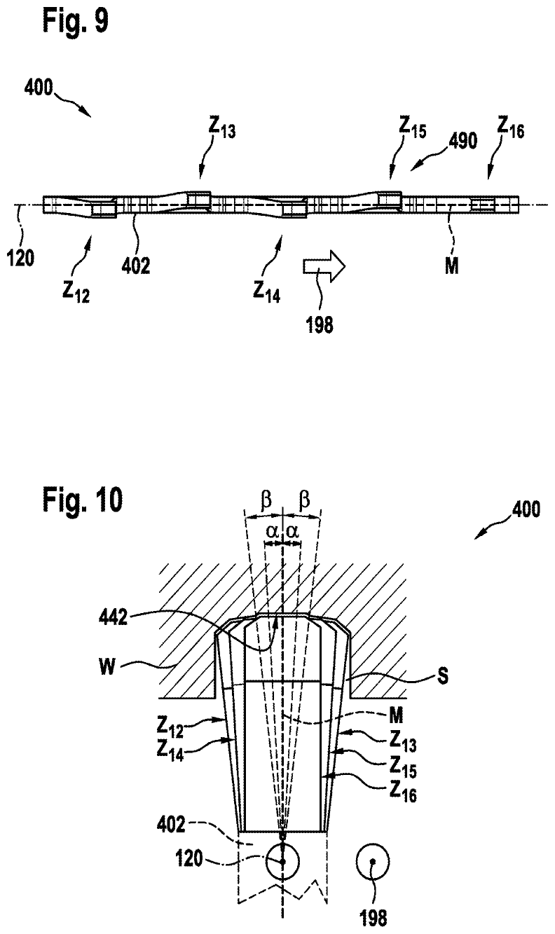

FIG. 9 shows a sixth embodiment of a sawblade 400, which preferably has a base section 402 on which in this case illustratively five teeth Z_{12, . . . , 16} are formed, the geometry of which corresponds merely by way of example to the structural design of the teeth of the first embodiment of the sawblade 100 of FIG. 1 to FIG. 3. The teeth Z_{12, . . . , 16} can also be designed with convexly rounded areas and/or with bevels having different widths.

The sawblade 400 having the base section 402 has the central plane M with the longitudinal axis 120 lying therein. The sawblade 400 is guided in the cutting direction 198 through the workpiece to be cut, which is not shown here.

In contrast to the fifth embodiment of the sawblade 350 according to FIG. 7 and FIG. 8, the tooth Z₁₆ which is furthest forward in the cutting direction 198 is in this case unset, while the two teeth Z_{14,15} directly following this tooth counter to the cutting direction 198 are set in opposite directions to one another at a first set angle (see FIG. 10). The further two teeth Z_{12,13} following the teeth Z_{14,15}, however, are set at a second set angle in opposite directions to one another, whereby the teeth Z_{12, . . . , 16} form a second set sequence 490. The second set sequence 490 is preferably repeated over the entire longitudinal extension of the sawblade 400.

FIG. 10 shows the five teeth Z_{12, . . . 16} of the sawblade 400 of FIG. 9. The sawblade 400 is illustratively located in the sawing channel S of the workpiece W. The sawblade 400 having the base section 402 is symmetrical with respect to the central plane M with the longitudinal axis 120 extending therein. The tooth Z₁₆ of the sawblade 400 lying farthest forward in the cutting direction is unset, whereas the teeth Z_{14,15} directly following this tooth counter to the cutting direction 198 are set in opposite directions to one another at the first set angle α. The two teeth Z_{12,13} directly following the teeth Z_{14,15} in the cutting direction 198, however, are set in opposite directions to one another at the second set angle β. In order to realize the second set sequence 490, the second set angle β is preferably greater than the first set angle α.

The shape of the teeth Z_{12, . . . 16} and their relevant structural design correspond only by way of example to the teeth of the first embodiment of the sawblade 100 according to FIG. 1 to FIG. 3. Owing to the design according to the invention of the sawblade 400 with the second set sequence 490, a sawing channel bottom 442 is characterized by further increased smoothness and a substantial freedom from stress cracks.

FIG. 11 shows the tooth Z₁, equipped with the hard metal blade 114, of the sawblade 100 of FIG. 1 to FIG. 3, said tooth illustratively having a thickness D, the width B₁ of the bevel F₁ and the width B₅ of the bevel F₂ preferably being approximately the same size. The widths B_{1,5} preferably correspond in each case to approximately 10% to 40% of the thickness D of the tooth Z₁. Preferably, the widths B_{1,5} of the bevels F_{1,2} are between 20% and 35% of the thickness D of the tooth Z₁, each including assigned interval limits. Two bevel angles γ_{1,2} of the two bevels F_{1,2} of the tooth Z₁ are preferably between 100 and 600 in relation to the upper face 170 of the hard metal blade 114 or the horizontal, preferably between 20° and 45°, in each case including assigned interval limits. The above-mentioned dimensioning ratios preferably apply accordingly to all further teeth of the sawblade 100.

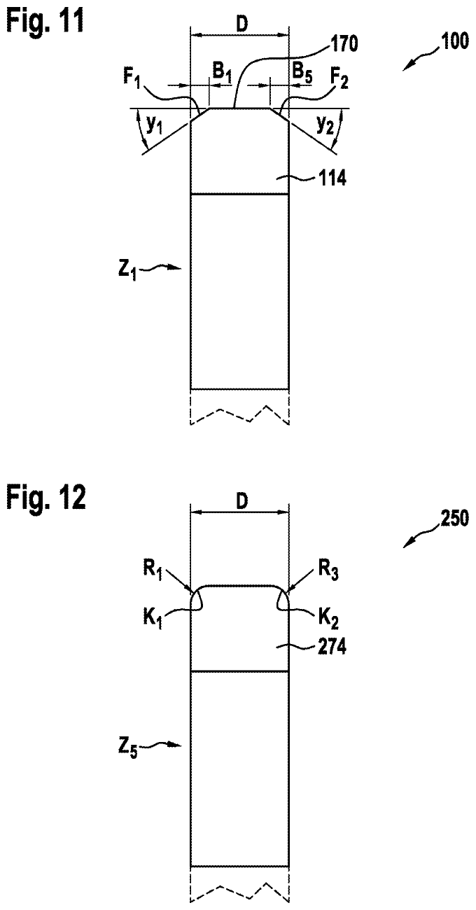

FIG. 12 shows the tooth Z₅, equipped with the hard metal blade 274, of the sawblade 250 according to FIG. 5, said tooth, like the tooth Z₁ of FIG. 11, illustratively having the thickness D. The radii R_{1,3} of the convexly rounded areas K_{1,3} here are preferably approximately between 10% to 40% of the thickness D, preferably 20% to 35% of the thickness D, in each case including assigned interval limits.

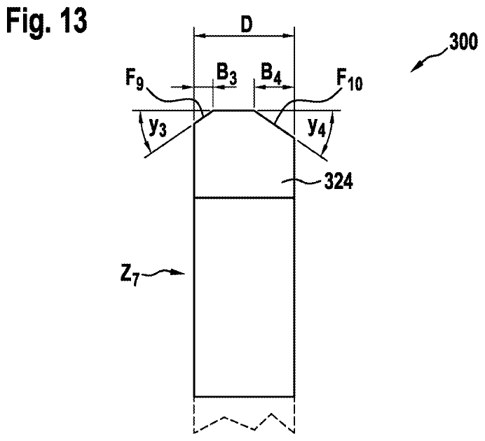

FIG. 13 shows the tooth Z₇, equipped with the hard metal blade 324, of the sawblade 300 according to FIG. 6, said tooth, like the tooth Z₁ of FIG. 11, illustratively having the thickness D. The widths of the bevels F_{9,10} preferably have different sizes. The ratio between the widths B_{3,4} and the thickness D of the tooth Z₇ preferably corresponds to the dimensioning ratio between the widths B_{1,5} of the bevels F_{1,2} and the thickness D of the tooth Z₁ of FIG. 11. The sizes of the bevel angles γ_{3,4} of the bevels F_{9,10} of the tooth Z₇ preferably correspond accordingly to the size specifications of the bevel angles γ_{1,2} of the bevels F_{1,2} of tooth Z₁ of FIG. 11.

The width B₄ of the bevel F₁₀ of the tooth Z₇ of the sawblade 300 is preferably selected to be larger than the width B₃ of the bevel F₉ of the tooth Z₇. In this case, the bevel angle γ₄ of the bevel F₁₀ is preferably not smaller than the bevel angle γ₃ of the bevel F₉. The dimensional ratios explained in the context of the description of FIG. 11 to FIG. 13 preferably apply to all teeth of the relevant embodiment of the sawblade according to the invention.

The six embodiments of the sawblades 100, 200, 250, 300, 350, 400 described above are preferably provided for use in power saws or hand saws of all types. With the aid of the sawblades 100, 200, 250, 300, 350, 400, a workpiece formed with plastics material, with wood, a mineral material or with metal can be cut. The sawblades 100, 200, 250, 300, 350, 400 can be used, for example, in a straight form. In such a configuration, the sawblades 100, 200, 250, 300, 350, 400 can be used, for example, in motor-driven jigsaws, hacksaws, straight backed saws, veneer saws or the like. Furthermore, the sawblades 100, 200, 250, 300, 350, 400 can also be used in a circular configuration with radially outwardly oriented teeth in motor-driven table saws or hand-held circular saws.

Furthermore, it is possible to bring the sawblades 100, 200, 250, 300, 350, 400 into a hollow cylindrical shape, wherein in such a configuration free ends of the sawblade are fixedly connected to one another in a suitable manner in order to create the continuous geometry. In this way, for example, a high-efficiency so-called hole saw (circular or annular cutter) can be provided, but is not shown in the figures. Furthermore, the sawblades 100, 200, 250, 300, 350, 400 can be used for example in a motorized band saw.

1. A sawblade comprising:
a plurality of wave-shaped teeth formed on a continuous base section of the sawblade, each tooth of the plurality of teeth having (i) an associated tooth base with a tooth base upper face and (ii) a respective hard metal blade arranged on the tooth base upper face of the associated tooth base,
wherein each associated tooth base adjoins the respective hard metal blade in a flush manner on both sides along a longitudinal axis of the base section,
wherein each respective hard metal blade and each tooth base upper face has two bevels and/or convexly rounded areas extending substantially along the longitudinal axis of the base section, and
wherein each tooth of the plurality of teeth is unset or set.

2. The sawblade according to claim 1, wherein the bevels of each respective hard metal blade have substantially the same width.

3. The sawblade according to claim 1, wherein the bevels of each tooth have different widths.

4. The sawblade according to claim 1, wherein the convex rounded areas have substantially the same radius.

5. The sawblade according to claim 1, wherein two directly successive teeth of the plurality of teeth are set in opposite directions to one another along the longitudinal axis.

6. The sawblade according to claim 1, wherein:
the plurality of teeth includes a sequence of teeth comprising:
at least one tooth that is unset; and
two teeth which directly follow said at least one tooth along the longitudinal axis, the two teeth being set in opposite directions to one another, and
the sequence is repeated along the longitudinal axis over all the teeth of the plurality of teeth.

7. The sawblade according to claim 1, wherein:
the plurality of teeth includes a sequence of teeth comprising:
at least one tooth that is unset;
a first pair of teeth which directly follow said at least one tooth along the longitudinal axis, the teeth of the first pair of teeth being set in opposite directions to one another at a first set angle; and
a second pair of teeth which directly follow the first pair of teeth along the longitudinal axis, the teeth of the second pair of teeth being set in opposite directions to one another at a second set angle, and
the sequence is repeated along the longitudinal axis over all the teeth of the plurality of teeth.

8. The sawblade according to claim 7, wherein the first set angle is smaller than the second set angle.

9. The sawblade according to claim 1, wherein the respective hard metal blades form a tooth tip above a concave chip space of each tooth, the tooth tips pointing in a cutting direction.

10. The sawblade according to claim 1, wherein the respective hard metal blades are fixedly connected to the associated tooth base.

11. The sawblade according to claim 1, wherein the base section of the sawblade is formed with a tempered steel, and the respective hard metal blades are formed with a tungsten carbide-cobalt hard metal.

12. A hole saw comprising:
a sawblade comprising:
a plurality of wave-shaped teeth formed on a continuous base section of the sawblade, each tooth of the plurality of teeth having (i) an associated tooth base with a tooth base upper face and (ii) a respective hard metal blade arranged on the tooth base upper face of the associated tooth base,
wherein each associated tooth base adjoins the respective hard metal blade in a flush manner on both sides along a longitudinal axis of the base section,
wherein each respective hard metal blade and each tooth base upper face has two bevels and/or convexly rounded areas extending substantially along the longitudinal axis of the base section,
wherein each tooth of the plurality of teeth is unset or set, and
wherein the sawblade is bent substantially into a ring.

13. The sawblade according to claim 10, wherein the respective hard metal blades are joined thermally to the associated tooth base.
